(19) United States
(12) Patent Application Publication
(10) Pub. No.: US 2025/0284186 A1
(43) Pub. Date: Sep. 11, 2025

(54) ILLUMINATION SYSTEM AND PROJECTION DEVICE

(71) Applicant: Coretronic Corporation, Hsin-Chu (TW)

(72) Inventor: Chang-Hsuan Chen, Hsin-Chu (TW)

(73) Assignee: Coretronic Corporation, Hsin-Chu (TW)

(21) Appl. No.: 19/062,020

(22) Filed: Feb. 25, 2025

Related U.S. Application Data
(60) Provisional application No. 63/562,699, filed on Mar. 8, 2024.

(30) Foreign Application Priority Data
May 7, 2024 (CN) 202410552352.1

(51) Int. Cl. G03B 21/20

(52) U.S. Cl. CPC G03B 21/2066; G03B 21/2013

(57) ABSTRACT

Provided is an illumination system including a light source module and a light guide module. The light source module includes a first light source module providing a first light beam toward a first direction, and a second light source module and a third light source module providing a second light beam and a third light beam toward a second direction. The light guide module includes a first light splitting element, a second light splitting element, and a reflecting mirror, wherein the second light splitting element is at the downstream of the first light splitting element. The light guide module enables the first light beam, the third light beam, and the second light beam to be transmitted along the second direction. The disclosure also provides a projection device.

### CROSS-REFERENCE TO RELATED APPLICATION

This application claims the priority benefit of U.S. provisional application Ser. No. 63/562,699, filed on Mar. 8, 2024 and China application serial no. 202410552352.1, filed on May 7, 2024. The entirety of the above-mentioned patent application is hereby incorporated by reference herein and made a part of this specification.

### BACKGROUND

### Technical Field

The disclosure relates to an optical system and an optical device, and in particular relates to an illumination system and a projection device.

### Description of Related Art

Recently, projection devices equipped with solid-state light sources, such as light-emitting diodes (LEDs) and laser diodes (LDs) have gradually gained a place in the market.

As the disposal density of light-emitting units in solid-state light sources increases, how to effectively utilize the light beams emitted from the light-emitting units, or optimize and improve the light collection efficiency of an optical element has also become a problem that needs to be solved today.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides an illumination system that may effectively improve the light efficiency of multiple light source modules.

The disclosure provides a projection device, of which an illumination system is small in size and good in light emission efficiency.

Other objectives and advantages of the disclosure may be further understood from the technical features disclosed in the disclosure.

In order to achieve one, part, or all of the above objectives or other objectives, an embodiment of the disclosure provides an illumination system including a light source module and a light guide module. The light source module includes a first light source module that provides a first light beam toward a first direction, and a second light source module and a third light source module that provide a second light beam and a third light beam toward a second direction. The first light source module and the second light source module are misaligned with each other in a third direction, and the second light source module and the third light source module are misaligned with each other in the third direction. Any two of the first direction, the second direction and the third direction are substantially perpendicular to each other. The light guide module includes a first light splitting element, a second light splitting element, and a reflecting mirror. The first light splitting element is configured to allow the second light beam to pass through, and to allow one of the first light beam and the third light beam, and the second light beam to be both transmitted along the second direction. The second light splitting element is configured to allow the second light beam to pass through, and to allow the first light beam, second light beam, and third light beam to be all transmitted along the second direction. The reflecting mirror guides the third light beam to the first light splitting element or the second light splitting element. The first light splitting element and the second light splitting element are stripe beam splitters, and stripe extension directions of the two light splitting elements are substantially orthogonal to each other.

In order to achieve one, part, or all of the above objectives or other objectives, an embodiment of the disclosure provides a projection device. The projection device includes the illumination system, a light valve and a projection lens. The illumination system is configured to provide an illumination light beam. The illumination light beam includes at least one of a first light beam, a second light beam, and a third light beam. The light valve is deployed on a transmission path of the illumination light beam and is configured to convert the illumination light beam into an image light beam. The projection lens is deployed on a transmission path of the image light beam and is configured to project the image light beam out of the projection device.

Based on the above, the embodiments of the disclosure have at least one of the following advantages or effects. In the embodiments of the disclosure, the first light splitting element and the second light splitting element are both stripe beam splitters, and the stripe extension directions of the two are orthogonal to each other, so that the optical paths of the light beams from the first light source module and the second light source module with two different light emitting directions may be effectively integrated. In addition, a reflecting mirror is further configured to guide the light beam of the third light source module, so that the light beams emitted by each of the three light source modules may be densely arranged. The light beams generated by the light source modules disposed in different directions may emit in the same direction after transmitting through the light guide module, reducing the complexity of the optical path design of multiple light source modules and further saving the space needed for the illumination system (or the projection device).

In order to make the above features and advantages of the disclosure more obvious and easy to understand, embodiments are given below and described in detail with reference to the accompanying drawings.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is an architectural schematic diagram of an illumination system according to an embodiment of the disclosure.

FIG. 2 is a schematic diagram of a light source module and a light guide module of the illumination system of FIG. 1.

FIG. 3 is a schematic diagram of an optical path of the illumination system of FIG. 1.

FIG. 4 is a schematic front-view diagram of the first light splitting element and the second light splitting element of FIG. 1.

FIG. 5A is an architectural schematic diagram of the light source module of FIG. 1.

FIG. 5B is a schematic diagram of a light spot distribution formed on a focus lens by the light beam emitted from the light source module of FIG. 5A.

FIG. 6 is an architectural schematic diagram of an illumination system according to an embodiment of the disclosure.

FIG. 7 is a schematic diagram of a light source module and a light guide module of the illumination system of FIG. 6.

FIG. 8 is a schematic diagram of an optical path of the illumination system of FIG. 6.

FIG. 9A is an architectural schematic diagram of the light source module of FIG. 6.

FIG. 9B is a schematic diagram of a light spot distribution formed on a focus lens by the light beam emitted from the light source module of FIG. 9A.

FIG. 10A and FIG. 10B are architectural schematic diagrams of a heat dissipation module according to an embodiment of the disclosure.

FIG. 11 is an architectural schematic diagram of a projection device according to an embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the present disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

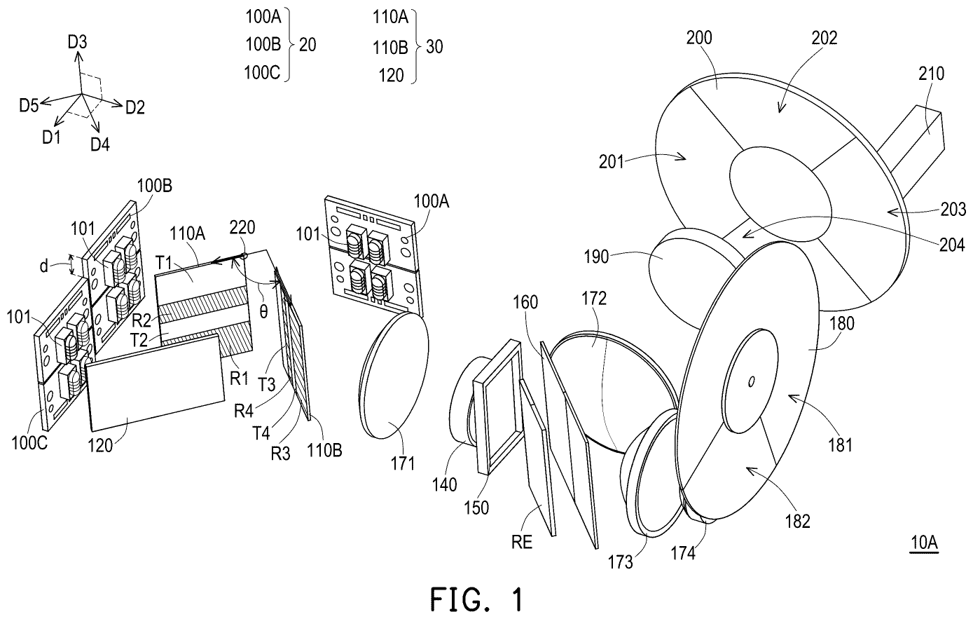

FIG. 1 is an architectural schematic diagram of an illumination system according to an embodiment of the disclosure. Referring to FIG. 1, an illumination system 10A includes a light source module 20 and a light guide module 30. The light guide module 30 is disposed on a transmission path of the light beam from the light source module 20, and includes a first light splitting element 110A, a second light splitting element 110B and a reflecting mirror 120, the second light splitting element 110B is at the downstream of the first light splitting element 110A. The light source module 20 may include a first light source module 100A, a second light source module 100B, and a third light source module 100C. In an embodiment, the illumination system 10A may also include other optical elements, such as focus lenses 171, 172, 173, and 174, a collimated lens 140, a diffusion plate 150, a color separation element 160, a phosphor wheel 180, a depolarizing plate 190, a filter wheel 200, and a light homogenizing element 210, etc.

The first light source module 100A, the second light source module 100B, and the third light source module 100C may all be substantially the same light source modules, and the wavelength ranges of the light beams emitted are substantially the same. In other embodiments, the first light source module 100A, the second light source module 100B, and the third light source module 100C may be configured to provide light beams in at least two different wavelength ranges. Any one of the above light source modules may include four light-emitting components 101, arranged in a 2×2 array. In other embodiments, any one of the above light source modules may only include 2×1 light-emitting components 101, and the light-emitting components 101 are arranged in a first direction D1, a second direction D2, or a third direction D3. The light-emitting components 101 may be a package component of a light-emitting diode, a package component of a laser diode, or a package component formed by a light-emitting diode and a laser diode. Any one of the light-emitting components 101 may include 3, 4, 5, 6, 7, or 8 light-emitting diodes, laser diodes, or a combination of the above. In this embodiment, each of the light-emitting components 101 may, for example, include 4 or 5 blue laser diodes.

In this embodiment, the first light source module 100A provides the first light beam L1 along the first direction D1, the second light source module 100B provides the second light beam L2 along the second direction D2, and the third light source module 100C provides the third light beam L3 along the second direction D2. The first light source module 100A and the second light source module 100B are misaligned with each other in the third direction D3, and the second light source module 100B and the third light source module 100C are misaligned with each other in the third direction D3. For example, the sizes of the second light source module 100B and the third light source module 100C may be substantially the same, and both the second light source module 100B and the third light source module 100C are located on a reference plane formed by the first direction D1 and the third direction D3, and in the third direction D3, there is a distance d between the two light source modules due to misalignment. In this embodiment, the first direction D1, the second direction D2, and the third direction D3 may be substantially perpendicular to each other in pair, and the third direction D3 is, for example, parallel to a gravity direction. Orthographic projections of the first light source module 100A, the second light source module 100B and the third light source module 100C on a reference plane perpendicular to the second direction D2 do not overlap, and orthographic projections of the second light source module 100B and the third light source module 100C on a reference plane perpendicular to the first direction D1 at least partially overlap. In other embodiments, the third direction D3 and the first direction D1 may also be horizontal directions, and the second direction D2 may be a vertical direction, and both the light source module 20 or the illumination system 10A as a whole are rotated 90 degrees.

The first light splitting element 110A is configured to allow the second light beam L2 from the second light source module 100B to pass through and guide the third light beam L3 from the third light source module 100C to transmit along the second direction D2. The second light splitting element 110B is configured to allow the second light beam L2 from the first light splitting element 110A to pass through, and to allow the first light beam L1, second light beam L2, and third light beam L3 to transmit toward the second direction D2. The first light splitting element 110A and the second light splitting element 110B are stripe beam splitters. An extension plane of the first light splitting element 110A may be parallel to a fifth direction D5, and an extension plane of the second light splitting element 110B may be parallel to a fourth direction D4. The fifth direction D5 and the fourth direction D4 may be, for example, parallel to a plane formed by the first direction D1 and the second direction D2, and the fifth direction D5 and the fourth direction D4 may be each orthogonal to the third direction D3.

A stripe beam splitter includes a reflection area and a transmission area, and the reflection area and the transmission area are presented as a stripe-shaped arrangement. The reflection area is, for example, an area having a material with a high reflectivity ratio for electromagnetic waves of a specific wavelength (such as a Bragg reflecting mirror or silver). The transmission area is, for example, an area having a material with high transmittance ratio for electromagnetic waves of a specific wavelength (such as glass, quartz, or sapphire substrate), or the transmission area is an air layer without disposing a substrate. The first light splitting element 110A is, for example, a stripe beam splitter extending in the fifth direction D5 and having a width in the third direction D3. An extension direction of the second light splitting element 110B is, for example, parallel to the third direction D3, and the second light splitting element 110B is a stripe beam splitter with the width in the fourth direction D4. The first light splitting element 110A is, for example, a stripe beam splitter with horizontal stripes, and the second light splitting element 110B is, for example, a stripe beam splitter with vertical stripes. In other embodiments, the first light splitting element 110A may also be a stripe beam splitter with vertical stripes, and the second light splitting element 110B may be a stripe beam splitter with horizontal stripes.

An included angle θ is formed between the extension plane of the first light splitting element 110A and the extension plane of the second light splitting element 110B in a direction facing away from the first light source module 100A. The range of the included angle θ is greater than 0 degrees and less than 180 degrees. On a reference plane perpendicular to the third direction D3, orthographic projections of the first light splitting element 110A and the second light splitting element 110B are presented as an inverted V shape. On the reference plane perpendicular to the first direction D1, orthographic projections of the second light splitting element 110B and the first light source module 100A at least partially overlap, and an orthographic projection of the reflecting mirror 120 and the orthographic projection of the first light splitting element 110A at least partially overlap. For example, an included angle of 45 degrees may be formed substantially between the extension plane of the first light splitting element 110A and a plane where the second light source module 100B and the third light source module 100C are located (that is, a plane formed by the first direction D1 and the third direction D3). An included angle of 45 degrees may be formed substantially between the extension plane of the second light splitting element 110B and a plane where the first light source module 100A (that is, a plane formed by the second direction D2 and the third direction D3) is located. Therefore, the included angle θ may be substantially 90 degrees. An extension plane of the reflecting mirror 120 may be substantially parallel to the extension plane of the first light splitting element 110A. In some embodiments, the first light source module 100A, the second light source module 100B, and the third light source module 100C may have tolerances during assembly. The first light splitting element 110A and the reflecting mirror 120 may also be slightly rotated or offset to fine-tune an angle that the light beam is guided to the second light splitting element 110B. Therefore, the included angle θ may also be an acute angle or an obtuse angle, and the range of the included angle θ is, for example, 80 degrees to 100 degrees, or 85 degrees to 95 degrees, or 87 degrees to 93 degrees.

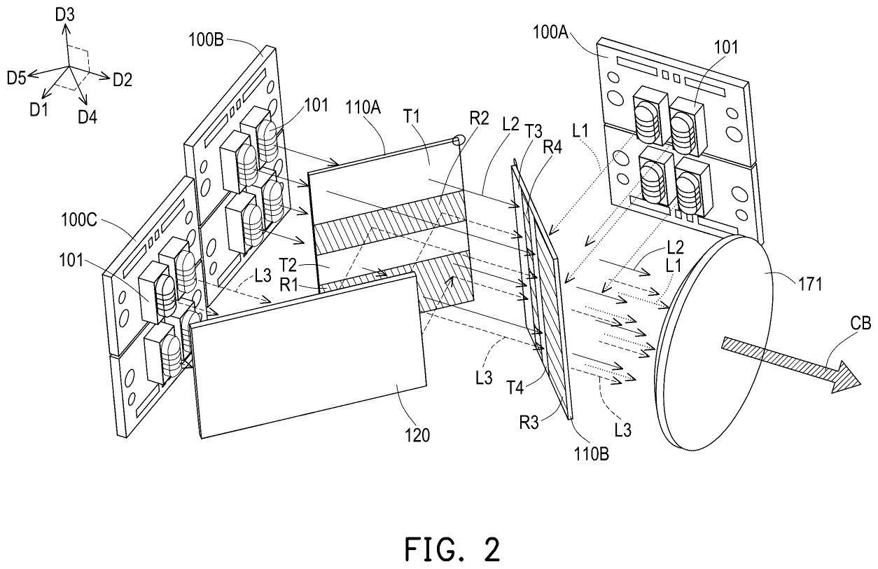

FIG. 2 is a schematic diagram of a light source module and a light guide module of the illumination system of FIG. 1. Referring to FIG. 2, the first light splitting element 110A and the second light splitting element 110B are disposed on a transmission path of the second light beam L2 from the second light source module 100B. The first light splitting element 110A has a first transmission area T1, a second transmission area T2, a first reflection area R1, and second reflection area R2. The second light splitting element 110B has a third transmission area T3, a fourth transmission area T4, a third reflection area R3, and a fourth reflection area R4. The second light beam L2 from the light-emitting components 101 of the second light source module 100B may be incident on the first transmission area T1 and/or the second transmission area T2 of the first light splitting element 110A, and incident on the third transmission area T3 and/or the fourth transmission area T4 of the second light splitting element 110B, and transmit to the focus lens 171. That is to say, the second light beam L2 irradiated to the focus lens 171 enters the focus lens 171 without being reflected by the light splitting element.

The first light splitting element 110A is configured to reflect the third light beam L3, so that the third light beam L3 is transmitted along the second direction D2. The second light splitting element 110B is configured to reflect the first light beam L1 so that the first light beam L1 is transmitted along the second direction D2, and the reflecting mirror 120 is configured to guide the third light beam L3 to the first light splitting element 110A.

The second light splitting element 110B is disposed on a transmission path of the first light beam L1 from the first light source module 100A. The first light beam L1 from the light-emitting components 101 of the first light source module 100A may be incident on the third reflection area R3 and/or the fourth reflection area R4 of the second light splitting element 110B, and then reflected to the focus lens 171 by the second light splitting element 110B.

The reflecting mirror 120 is disposed on a transmission path of the third light beam L3 from the third light source module 100C. The third light beam L3 from the light-emitting components 101 of the third light source module 100C may be first incident on the reflecting mirror 120 along the second direction D2 and reflected to the first reflection area R1 and/or the second reflection area R2 of the first light splitting element 110A, and then the third light beam L3 may be reflected again by the first reflection area R1 and/or the second reflection area R2 to the second light splitting element 110B, and finally the third light beam L3 may be incident on the third transmission area R3 and/or the fourth transmission area R4 of the second light splitting element 110B along the second direction D2 to transmit to the focus lens 171. The first light beam L1, the second light beam L2, and the third light beam L3 may be all guided to the second direction D2 to form a combined light beam CB. The combined light beam CB includes at least one of the first light beam L1, the second light beam L2, and the third light beam L3. The combined light beam CB includes, for example, multiple blue laser light beams.

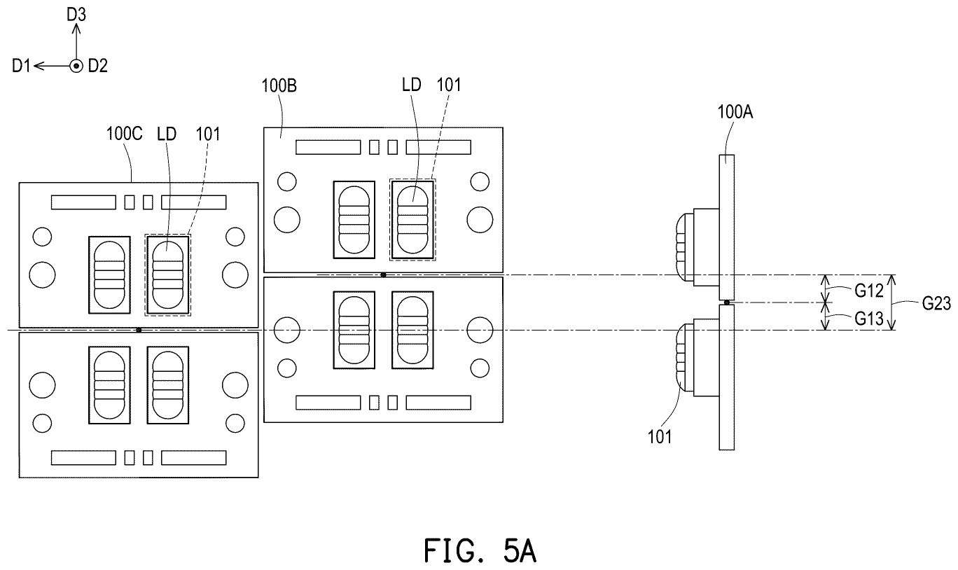

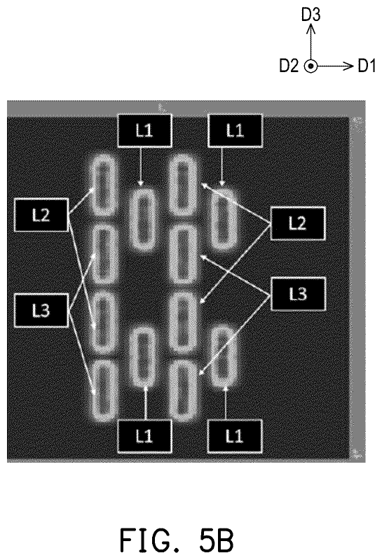

FIG. 5A is an architectural schematic diagram of the light source module of FIG. 1. FIG. 5B is a schematic diagram of a light spot distribution formed on a focus lens by light beam emitted from the light source module of FIG. 5A. In FIG. 5B, an outline of light spots is used to illustrate distribution positions of multiple light spots. Please refer to FIG. 5A and FIG. 5B at the same time. Since the first light source module 100A and the second light source module 100B are misaligned in the third direction D3, and the third light source module 100C and the second light source module 100B are misaligned in the third direction D3, the center of the first light source module 100A and the center of the second light source module 100B have a gap G12 in the third direction D3, and the center of the second light source module 100B and the center of the third light source module 100C have a gap G23 in the third direction D3. The first light source module 100A and the third light source module 100C are misaligned in the third direction D3, and the center of the first light source module 100A and the center of the third light source module 100C have a gap G13 in the third direction D3. The first light source module 100A, the second light source module 100B, and the third light source module 100C may all be misaligned with each other in the third direction D3. In the third direction D3, the center of the first light source module 100A is between the center of the second light source module 100B and the center of the third light source module 100C.

In this embodiment, the gap G23 may be larger than the gap G12. Therefore, on the light incident surface of the focus lens 171, an interval of the light spots formed by the second light beam L2 and the third light beam L3 (from a center of the light spot L2 to a center of the light spot L3 which is closest to the light spot L2 shown in FIG. 5B) in the third direction D3 may be larger than an interval of the light spots formed by the first light beam L1 and the second light beam L2 (from a center of the light spot L1 to a center of the light spot L2 which is closest to the light spot L1 shown in FIG. 5B) in the third direction D3. In this embodiment, optical paths of the second light beam L2 and the third light beam L3 are first integrated through the first light splitting element 110A. The third light beam L3 is reflected by the reflection area of the first light splitting element 110A. The second light beam L2 passes through the transmission area of the first light splitting element 110A. Then the optical paths of the second light beam L2 and the third light beam L3 are integrated with an optical path of the first light beam L1 through the second light splitting element 110B. The second light beam L2 and the third light beam L3 pass through the transmission area of the second light splitting element 110B. The first light beam L1 is reflected by the reflection area of the second light splitting element 110B. In the first direction D1, the light spots formed by the first light beam L1 on the focus lens 171 and the light spots formed by the second light beam L2 are alternately arranged, and the light spots formed by the first light beam L1 on the focus lens 171 and the light spots formed by the third light beam L3 are alternately arranged, so that the light spots formed by each of the light beams may be arranged as closely as possible. Through coordination of the light source module 20 and the light guide module 30 on the above optical path, a light beam density of the combined light beam CB may be effectively increased.

The multiple light-emitting components 101 in any one of the first light source module 100A, the second light source module 100B, and the third light source module 100C are arranged at intervals from each other. For example, there are intervals between the four light-emitting components 101 on the first light source module 100A. FIG. 5A also schematically illustrates each of the light-emitting components 101, including five light-emitting units LD, and the five light-emitting units LD are all arranged in the third direction D3. The light-emitting units LD may be, for example, the blue laser diode mentioned previously.

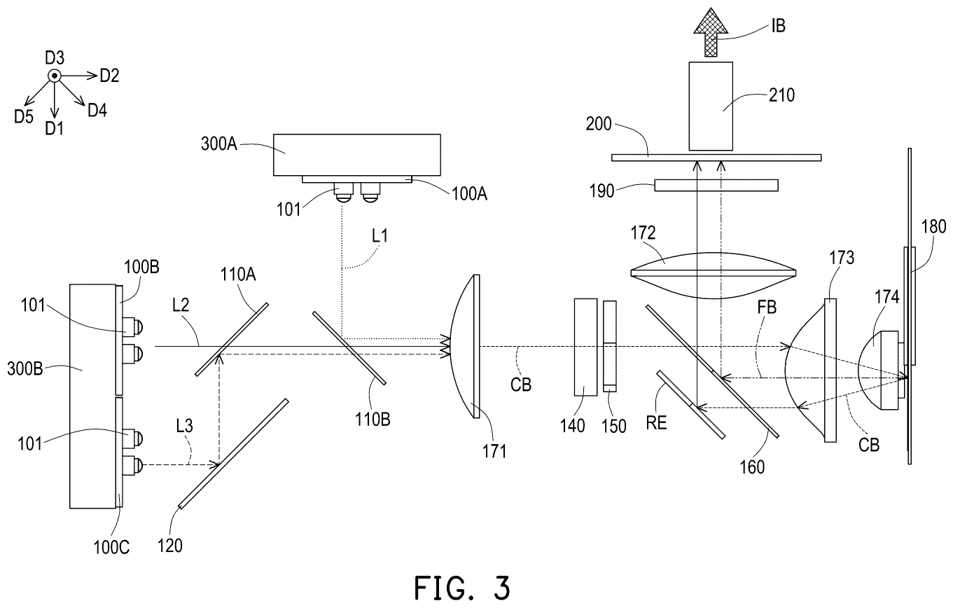

FIG. 3 is a schematic diagram of an optical path of the illumination system of FIG. 1. Referring to FIG. 3, the combined light beam CB from the focus lens 171 may be transmitted in sequence to the collimated lens 140, the diffusion plate 150, the color separation element 160, the focus lenses 173, 172, and 174, and the phosphor wheel 180. The phosphor wheel 180 may, in time sequence, convert the combined light beam CB into a converted light beam FB (such as fluorescent light) and reflect the combined light beam CB to an optical element RE (such as a reflecting mirror). Then, the converted light beam FB and the combined light beam CB may, in time sequence, further transmit to the color separation element 160, the focus lens 172, the depolarizing plate 190, the filter wheel 200, and the light homogenizing element 210.

In this embodiment, the diffusion plate 150 may be, for example, disposed on a side of the collimated lens 140 away from the focus lens 171. The collimated lens 140 is configured to allow the combined light beam CB traveling in a consistent direction. The diffusion plate 150 is configured to eliminate speckles of the combined light beam CB. The diffusion plate 150 may be an actuated diffusion plate or a diffuser wheel.

The color separation element 160 is disposed on a transmission path of the combined light beam CB from the light source module 20 and the light guide module 30. The color separation element 160 may be a dichroic element, a polarizing light splitting element, or other various elements that may separate light beams. For example, in this embodiment, the color separation element 160 may, for example, allow blue light beams to pass through and reflect the light beams of other colors (such as red, green, yellow, etc.). The color separation element 160 may allow the blue combined light beam CB to pass through and be incident on the phosphor wheel 180.

The phosphor wheel 180 is located on a transmission path of the combined light beam CB. The light conversion area 181 of the phosphor wheel 180 is adaptable for converting the combined light beam CB into at least one converted light beam FB, and the reflection area 182 of the phosphor wheel 180 is adaptable for reflecting the combined light beam CB and transmitting the combined light beam CB to the optical element RE. The phosphor wheel 180 further includes an actuator (not shown), which is adaptable to allow the reflection area 182 and the light conversion area 181 to locate on the transmission path of the combined light beam CB in different time sequences.

The depolarizing plate 190 may be configured to eliminate the polarization state of the combined light beam CB to reduce the generation of speckles. The depolarizing plate 190 is, for example, a depolarizer.

The filter wheel 200 is disposed on a transmission path of the combined light beam CB and the converted light beam FB from the color separation element 160. For example, the filter wheel 200 may include a transparent substrate (not shown), filter areas 201, 202, and 203 disposed on the transparent substrate, a transparent area 204, and a rotating shaft (not shown) passing through the transparent substrate. The filter areas 201, 202, and 203 may be, for example, red light filter patterns, blue light filter patterns, and green light filter patterns respectively, and the filter wheel 200 may rotate according to an axis thereof, so that these filter areas 201, 202, and 203 may be located in sequence and repeatedly on the transmission path of the combined light beam CB and the converted light beam FB. The combined light beam CB and at least one converted light beam FB pass through the filter wheel 200 may be formed into a blue light beam, a red light beam, or a green light beam, and, in this way, form an illumination light beam IB. The illumination light beam IB includes at least one of the blue light beam, the red light beam, and the green light beam.

The light homogenizing element 210 is disposed on a transmission path of the illumination light beam IB from the filter wheel 200. The light homogenizing element 210 may be disposed on a side of the filter wheel 200 away from the depolarizing plate 190 to achieve the effect of beam shaping and homogenization for the illumination light beam IB. The light homogenizing element 210 is, for example, an integrator rod or a fly-eye-lens type optical integrator.

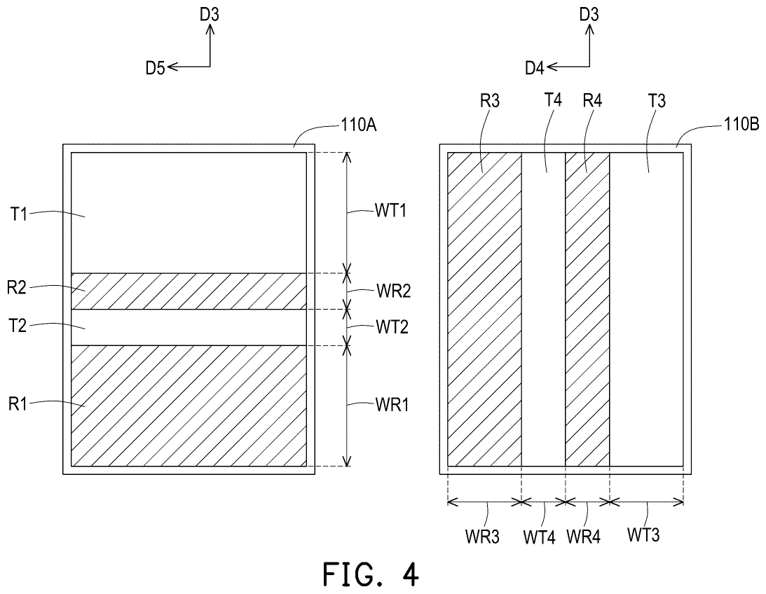

FIG. 4 is a schematic front-view diagram of the first light splitting element and the second light splitting element of FIG. 1. Referring to FIG. 4, in this embodiment, the first transmission area T1, the second reflection area R2, the second transmission area T2, and the first reflection area R1 of the first light splitting element 110A in the third direction D3 are arranged in sequence. A width WT1 of the first transmission area T1 in the third direction D3 is greater than a width WT2 of the second transmission area T2 in the third direction D3. A width WR1 of the first reflection area R1 in the third direction D3 is greater than a width WR2 of the second reflection area R2 in the third direction D3.

Since the width WR1 and the width WT1 are greater, the first reflection area R1 and the first transmission area T1 have larger areas, and part of the areas may be configured as a clamping area of a fixed component (such as a holding component 220 in FIG. 1). In other embodiments, the widths WR1, WR2, WT1, and WT2 may be all substantially the same. In some embodiments, the width WT1 of the first transmission area T1 may be substantially the same as the width WR1 of the first reflection area R1, and the width WT2 of the second transmission area T2 may be substantially the same as the width WR2 of the second reflection area R2.

The third reflection area R3, the fourth transmission area T4, the fourth reflection area R4, and the third transmission area T3 of the second light splitting element 110B in the fourth direction D4 are arranged in sequence. The width WT3 of the third transmission area T3 in the fourth direction D4 is greater than the width WT4 of the fourth transmission area T4 in the fourth direction D4. A width WR3 of the third reflection area R3 in the fourth direction D4 is greater than a width WR4 of the fourth reflection area R4 in the fourth direction D4. In other embodiments, the widths WR3, WR4, WT3, and WT4 may be all substantially the same. In some embodiments, the width WT3 of the third transmission area T3 may be substantially the same as the width WR3 of the third reflection area R3, and the width WT4 of the fourth transmission area T4 may be substantially the same as the width WR4 of the fourth reflection area R4.

In some embodiments, the width WT2 of the second transmission area T2 and the width WR2 of the second reflection area R2 may be respectively greater than the width WT4 of the fourth transmission area T4 and the width WR4 of the fourth reflection area R4. Since a beam divergence angle of each of the light-emitting components 101 in the third direction D3 parallel to the gravity direction is larger, a greater width for the width WT2 of the second transmission area T2 of the first light splitting element 110A is beneficial to the transmission of the second light beam L2, and a greater width for the width WR2 of the second reflection area R2 is also beneficial to the reflection of the third light beam L3, so that the light use efficiency of the light guide module 30 is increased. Moreover, the beam divergence angle of each of the light-emitting components 101 in the third direction D3 parallel to the gravity direction is larger, and the beam divergence angle in the first direction D1/the second direction D2 is smaller, therefore, the optical path of the light beam is first integrated through the first light splitting element 110A (a horizontal-striped beam splitter), and then the optical path of the light beam is integrated through the second light splitting element 110B (a vertical-striped beam splitter), and the effect of increasing light collection efficiency may be achieved.

Other embodiments may be enumerated below to explain the disclosure in detail, in which the same components are marked with the same symbols, and explanations of the same technical content are omitted. Please refer to the previous embodiments for the omitted parts, which may not be described again.

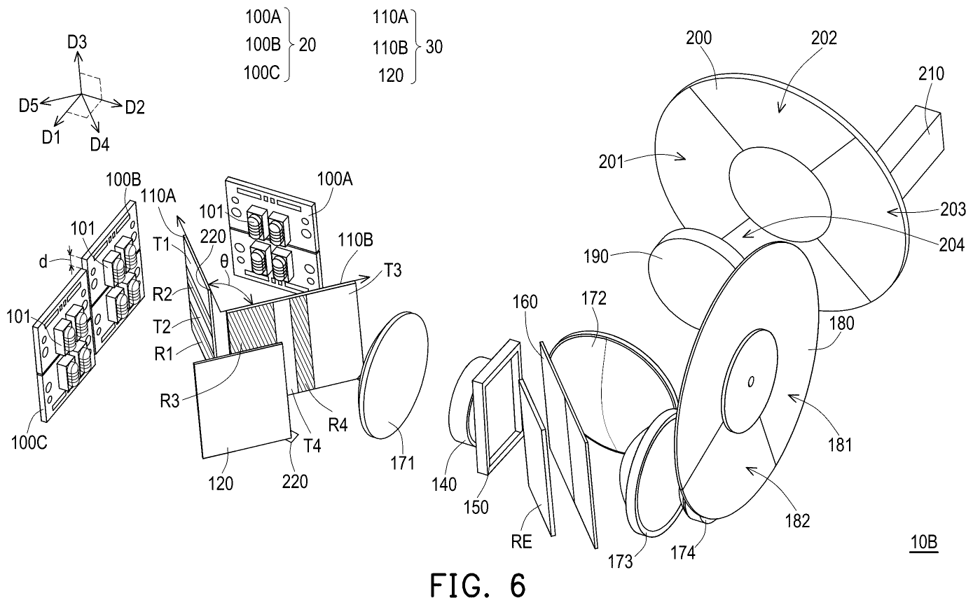

FIG. 6 is an architectural schematic diagram of an illumination system according to an embodiment of the disclosure. Referring to FIG. 6, an illumination system 10B is similar to the illumination system 10A of FIG. 1, where the main difference thereof lies in: the difference in deployment of the light guide module 30. In the illumination system 10B, the first light splitting element 110A is configured to allow the second light beam L2 to pass through, and is configured to allow the first light beam L1 to transmit along the second direction D2. The second light splitting element 110B is configured to allow the second light beam L2 to pass through, and is configured to allow the third light beam L3 to transmit along the second direction D2. The reflecting mirror 120 is configured to guide the third light beam L3 to the second light splitting element 110B.

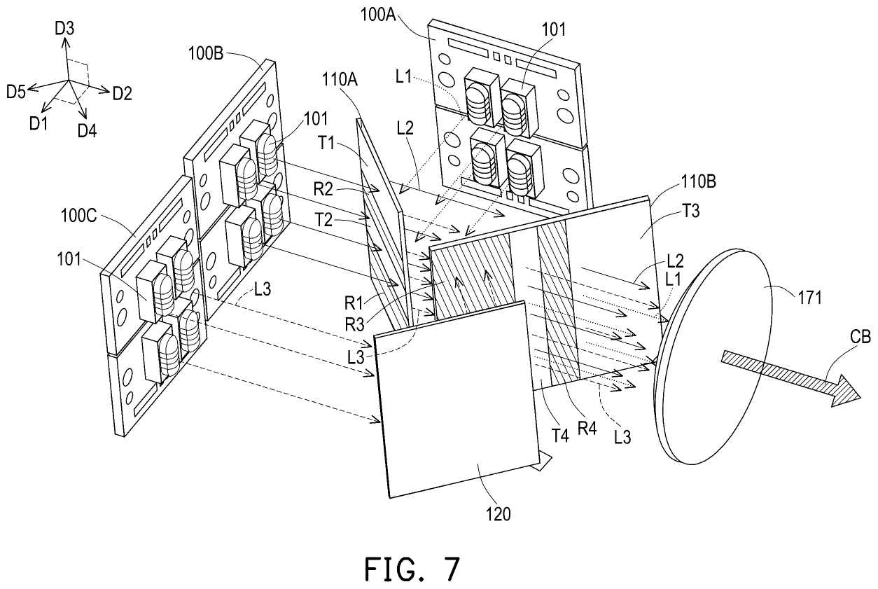

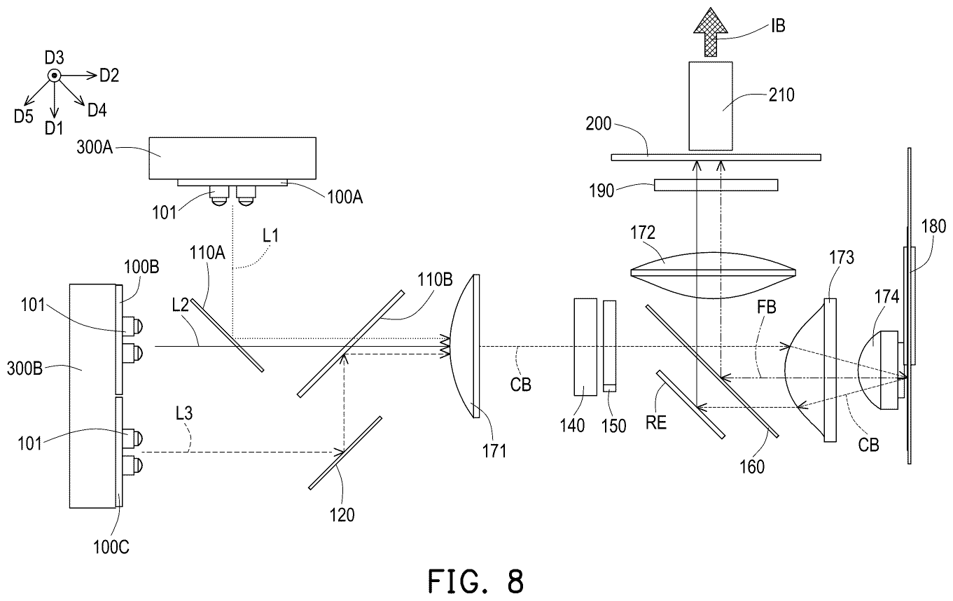

FIG. 7 is a schematic diagram of a light source module and a light guide module of the illumination system of FIG. 6. FIG. 8 is a schematic diagram of an optical path of the illumination system of FIG. 6. Then please refer to FIG. 6, FIG. 7, and FIG. 8. An included angle θ is formed between the extension plane of the first light splitting element 110A of the illumination system 10B and the extension plane of the second light splitting element 110B in a direction toward the first light source module 100A (as shown in FIG. 6). On the reference plane perpendicular to the third direction D3, orthographic projections of the first light splitting element 110A and the second light splitting element 110B are presented as V-shaped. On the reference plane perpendicular to the first direction D1, orthographic projections of the first light splitting element 110A and the first light source module 100A at least partially overlap, and an orthographic projection of the reflecting mirror 120 and an orthographic projection of the second light splitting element 110B at least partially overlap. The first light beam L1 from the first light source module 100A may be incident on the first reflection area R1 and/or the second reflection area R2 of the first light splitting element 110A and be reflected thereof. Then the first light beam L1 may be incident on the third transmission area T3 and/or the fourth transmission area T4 of the second light splitting element 110B to transmit to the focus lens 171.

The second light beam L2 from the second light source module 100B may be incident on the first transmission area T1 and/or the second transmission area T2 of the first light splitting element 110A along the second direction D2, and then the second light beam L2 may be incident on the third transmission area T3 and/or the fourth transmission area T4 of the second light splitting element 110B to transmit to the focus lens 171. That is to say, the second light beam L2 irradiated to the focus lens 171 enters the focus lens 171 without being reflected by the light splitting element. The third light beam L3 from the third light source module 100C is first incident on the reflecting mirror 120 along the second direction D2, and is guided to the third reflection area R3 and/or the fourth reflection area R4 of the second light splitting element 110B along a negative first direction D1. Moreover, the third light beam L3 is then reflected by the third reflection area R3 and/or the fourth reflection area R4 and transmitted to the focus lens 171 along the second direction D2. Accordingly, at least one of the first light beam L1, the second light beam L2, and the third light beam L3 may form the combined light beam CB, and then be converted into the illumination light beam IB by remaining optical devices on the subsequent optical path, as shown in FIG. 8 and mentioned in the previous paragraphs.

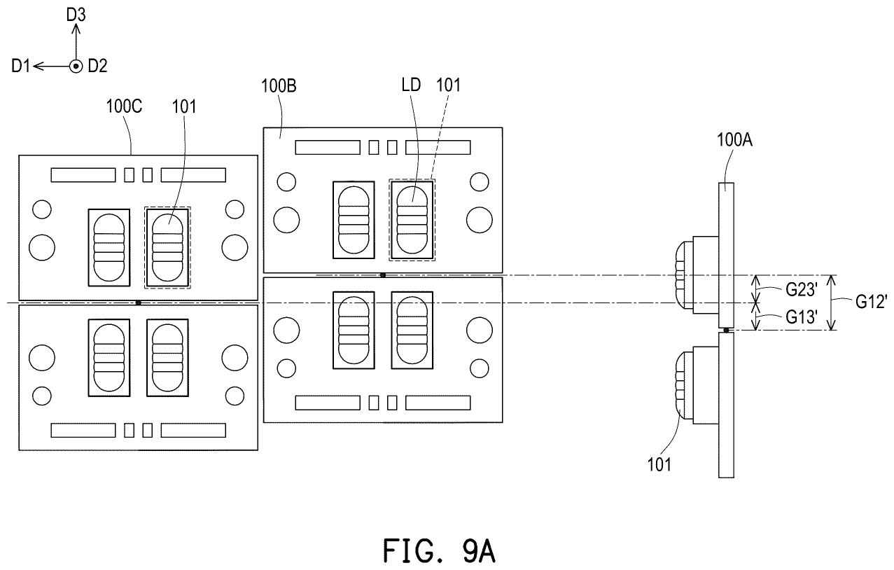

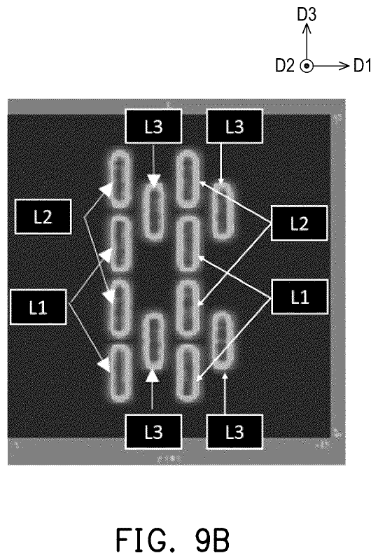

FIG. 9A is an architectural schematic diagram of the light source module of FIG. 6. FIG. 9B is a schematic diagram of a light spot distribution formed on a focus lens by the light beam emitted from the light source module of FIG. 9A. In FIG. 9B, an outline of light spots is used to illustrate distribution positions of multiple light spots. The center of the first light source module 100A and the center of the second light source module 100B in the third direction D3 may have a gap G12′, and the center of the second light source module 100B and the center of the third light source module 100C in the third direction D3 may have a gap G23′. The first light source module 100A and the third light source module 100C may also be misaligned in the third direction D3. The center of the first light source module 100A and the center of the third light source module 100C in the third direction D3 may have a gap G13′. In the third direction D3, the center of the third light source module 100C is located between the center of the first light source module 100A and the center of the second light source module 100B. In the illumination system 10B, the length of the gap G23′ is less than the length of the gap G12′. As shown in FIG. 9B, an interval of light spots formed by the second light beam L2 and the third light beam L3 (from a center of the light spot L2 to a center of the light spot L3 which is closest to the light spot L2 shown in FIG. 9B) in the third direction D3 is smaller than an interval of light spots formed by the first light beam L1 and the second light beam L2 (from a center of the light spot L1 to a center of the light spot L2 which is closest to the light spot L1 in FIG. 9B) in the third direction D3. In this embodiment, the optical paths of the first light beam L1 and the second light beam L2 are first integrated through the first light splitting element 110A. The first light beam L1 is reflected by the reflection area of the first light splitting element 110A. The second light beam L2 passes through the transmission area of the first light splitting element 110A. Then the optical paths of the first light beam L1 and the second light beam L2, and the optical path of the third light beam L3 are integrated through the second light splitting element 110B. The first light beam L1 and the second light beam L2 pass through the transmission area of the second light splitting element 110B. The third light beam L3 is reflected by the reflection area of the second light splitting element 110B. Light spots formed by the third light beam L3 on the focusing lens 171 may be alternately arranged with light spots formed by the first light beam L1 and the second light beam L2 in the first direction D1, so that light spots formed between each of the light beams are arranged as closely as possible.

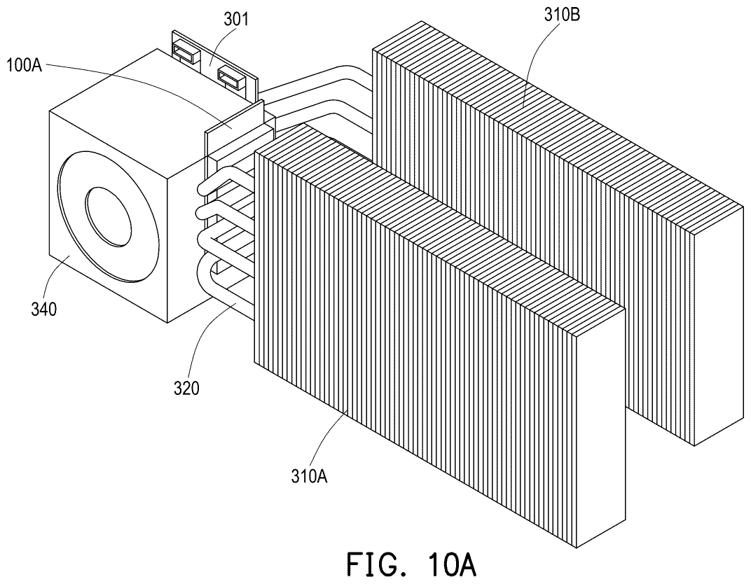

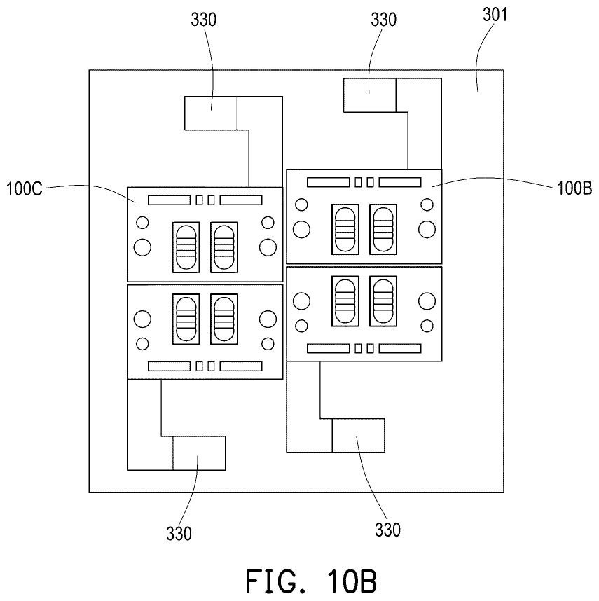

FIG. 10A and FIG. 10B are architectural schematic diagrams of a heat dissipation module according to an embodiment of the disclosure. Please refer to FIG. 10A, FIG. 10B, and FIG. 3 or FIG. 8 at the same time. The illumination system 10A (or the illumination system 10B) may further include a first heat-dissipation module 300A and a second heat-dissipation module 300B. The first light source module 100A may be disposed on the first heat-dissipation module 300A, and the second light source module 100B and the third light source module 100C may be both disposed on the second heat-dissipation module 300B. In other embodiments, the first light source module 100A, the second light source module 100B, and the third light source module 100C may be each provided with the corresponding heat dissipation module configured to dissipate heat.

The first heat dissipation module 300A and/or the second heat dissipation module 300B may include a circuit board 301, heat dissipation fins 310A and 310B, a heat conducting pipe 320, a heat dissipation pad 330 and a support base 340. The first light source module 100A, the second light source module 100B, and the third light source module 100C may be disposed on the circuit board 301, and the light guide module 30 may be disposed in the support base 340. The second light source module 100B and the third light source module 100C may share the same circuit board 301. The heat of the light source module 20 is transmitted to the heat conducting pipe 320 through the heat dissipation pad 330, and then the heat conducting pipe 320 transmits the heat to the heat dissipation fin 310B and discharges the heat out of the light source module 20. The heat conducting pipe 320 is, for example, a heat pipe of a metal material with high thermal conductivity (such as a copper pipe), and a heat conducting fluid (such as water vapor) is disposed in the space of the heat pipe to facilitate the transmission and release of heat. Since bending the heat conducting pipe 320 may reduce the heat conduction efficiency thereof, the heat conducting pipe 320 of this embodiment may be bent only once to connect the heat dissipation pad 330, and the heat dissipation fins 310A and 310B to each other to improve the heat conduction efficiency of the first heat dissipation module 300A or the second heat dissipation module 300B as much as possible.

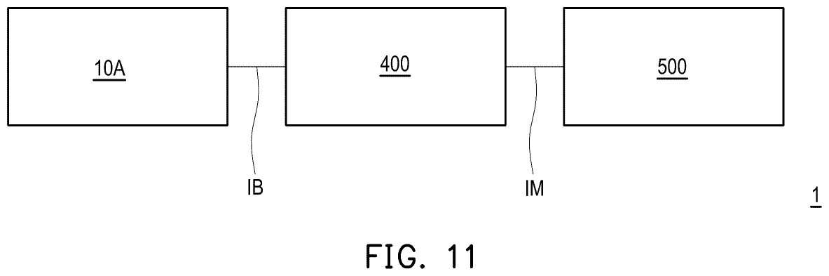

FIG. 11 is an architectural schematic diagram of a projection device according to an embodiment of the disclosure. Referring to FIG. 11, a projection device 1 (such as a projector) includes the illumination system 10A, a light valve 400, and a projection lens 500. The illumination system 10A is configured to provide the illumination light beam IB. The light valve 400 is disposed on a transmission path of the illumination light beam IB from the illumination system 10A, and is configured to convert the illumination light beam IB into an image light beam IM. The light valve 400 may include a digital micro-mirror device (DMD), a reflective liquid crystal on silicon (LCoS), or a transmissive spatial light modulator (SLM), such as a light-transmitting LCD panel.

The projection lens 500 is disposed on a transmission path of the image beam IM from the light valve 400, and is adaptable for projecting the image beam IM from the light valve 400 out of the projection device 1 to the imaging surface (not shown). The projection lens 500 may be any type of lens module known to those with ordinary skill in the technical field of the disclosure, and the disclosure is not limited thereto. The above is based on the illumination system 10A providing the illumination beam IB applied in the projection device 1 for explanation. In other embodiments, the illumination system 10B may also be selected to provide the illumination beam IB applied in the projection device 1.

In summary, the embodiments of the disclosure at least have one of the following advantages or effects. In the embodiment of the disclosure, the first light splitting element and the second light splitting element are both stripe beam splitters, and the stripe extension directions of the two light splitting elements are orthogonal to each other, so that the optical paths of the light beams of the first light source module and the second light source module from two different light emitting directions may be effectively integrated. In addition, the reflecting mirror is further coordinated to guide the light beam of the third light source module, so that the light beam emitted by the three light source modules respectively may be densely arranged. The light beams generated by the light source modules disposed in different directions may emit light toward the same direction after passing through the light guide module, reducing the complexity of the optical path design of multiple light source modules and further saving the space needed to be configured for the illumination system (or the projection device). Moreover, the structure of the light guide module is simple, so that the angle and/or the position of the first light splitting element, the second light splitting element, or the reflecting mirror may be easily adjusted, and the optical path of the light beam of each light source module or the light spot intensity formed by the light beam may also be easily adjusted to improve the quality of the image beam.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. An illumination system, comprising a light source module and a light guide module, wherein the light source module comprises:
a first light source module, providing a first light beam along a first direction;
a second light source module, providing a second light beam along a second direction, wherein the first light source module and the second light source module are misaligned in a third direction, and any two of the first direction, the second direction, and the third direction are substantially perpendicular to each other; and
a third light source module, providing a third light beam along the second direction, wherein the third light source module and the second light source module are misaligned in the third direction; and
the light guide module is configured to guide the first light beam, the second light beam and the third light beam along the second direction, the light guide module comprises:
a first light splitting element, configured to allow the second light beam to pass through;
a second light splitting element, configured to allow the second light beam to pass through, the second light splitting element is at the downstream of the first light splitting element; and
a reflecting mirror, configured to guide the third light beam to the first light splitting element or the second light splitting element;
wherein the first light splitting element and the second light splitting element are stripe beam splitters, and a stripe extension direction of the first light splitting element and a stripe extension direction of the second light splitting element are substantially orthogonal to each other.

2. The illumination system according to claim 1, wherein the first light splitting element is configured to reflect the third light beam so that the third light beam is transmitted along the second direction, the second light splitting element is configured to reflect the first light beam so that the first light beam is transmitted along the second direction, and the reflecting mirror is configured to guide the third light beam to the first light splitting element.

3. The illumination system according to claim 1, wherein the first light source module, the second light source module, and the third light source module are misaligned with each other in the third direction.

4. The illumination system according to claim 1, wherein any one of the first light source module, the second light source module, and the third light source module comprises a plurality of light-emitting components, each of the plurality of light-emitting components comprising a plurality of light-emitting units.

5. The illumination system according to claim 4, wherein the plurality of light-emitting components of any one of the first light source module, the second light source module, and the third light source module are arranged at intervals from each other.

6. The illumination system according to claim 1, wherein the stripe extension direction of the first light splitting element is parallel to a plane formed by the first direction and the second direction, and the stripe extension direction of the second light splitting element is parallel to the third direction.

7. The illumination system according to claim 1, wherein an included angle is formed between an extension plane of the first light splitting element and an extension plane of the second light splitting element in a direction facing away from the first light source module, and the included angle is greater than 0 and less than 180 degrees.

8. The illumination system according to claim 1, wherein an included angle is formed between an extension plane of the first light splitting element and an extension plane of the second light splitting element in a direction toward the first light source module, and the included angle is greater than 0 and less than 180 degrees.

9. The illumination system according to claim 1, wherein the first light splitting element further comprises:
a first transmission area and a second transmission area, wherein a width of the first transmission area in the third direction is greater than a width of the second transmission area in the third direction; and
a first reflection area and a second reflection area, wherein a width of the first reflection area in the third direction is greater than a width of the second reflection area in the third direction.

10. The illumination system according to claim 9, wherein the width of the first transmission area and the width of the first reflection area are substantially the same, and the width of the second transmission area and the width of the second reflection area are substantially the same.

11. The illumination system according to claim 9, wherein the first transmission area, the second reflection area, the second transmission area, and the first reflection area are arranged in sequence in the third direction.

12. The illumination system according to claim 9, wherein the second light splitting element comprises:
a third transmission area and a fourth transmission area, wherein a width of the third transmission area in a fourth direction is greater than a width of the fourth transmission area in the fourth direction; and
a third reflection area and a fourth reflection area, wherein a width of the third reflection area in the fourth direction is greater than a width of the fourth reflection area in the fourth direction, wherein the third direction is orthogonal to the fourth direction.

13. The illumination system according to claim 12, wherein the width of the third transmission area and the width of the third reflection area are substantially the same, and the width of the fourth transmission area and the width of the fourth reflection area are substantially the same.

14. The illumination system according to claim 12, wherein the third reflection area, the fourth transmission area, the fourth reflection area, and the third transmission area are arranged in sequence in the fourth direction.

15. The illumination system according to claim 12, wherein the width of the second transmission area and the width of the second reflection area are greater than the width of the fourth transmission area and the width of the fourth reflection area.

16. The illumination system according to claim 12, wherein the first light beam from the first light source module is incident on the third reflection area and/or the fourth reflection area of the second light splitting element.

17. The illumination system according to claim 12, wherein the third light beam from the third light source module is incident on the reflecting mirror and is guided to the first reflection area and/or the second reflection area of the first light splitting element, and the third light beam is incident on the third transmission area and/or the fourth transmission area of the second light splitting element.

18. The illumination system according to claim 12, wherein the first light beam from the first light source module is incident on the first reflection area and/or the second reflection area of the first light splitting element, and the first light beam is incident on the third transmission area and/or the fourth transmission area of the second light splitting element.

19. The illumination system according to claim 12, wherein the third light beam from the third light source module is incident on the reflecting mirror and is guided to the third reflection area and/or the fourth reflection area of the second light splitting element.

20. The illumination system according to claim 12, wherein the second light beam from the second light source module is incident on the first transmission area and/or the second transmission area of the first light splitting element, and the second light beam is incident on the third transmission area and/or the fourth transmission area of the second light splitting element.

21. A projection device, comprising an illumination system, a light valve, and a projection lens, the illumination system configured to provide an illumination light beam, the illumination system comprising a light source module and a light guide module, wherein the light source module comprises:
a first light source module, providing a first light beam along a first direction;
a second light source module, providing a second light beam along a second direction, wherein the first light source module and the second light source module are misaligned in a third direction, and any two of the first direction, the second direction, and the third direction are substantially perpendicular to each other; and
a third light source module, providing a third light beam along the second direction, wherein the third light source module and the second light source module are misaligned in the third direction; and
the light guide module is configured to guide the first light beam, the second light beam and the third light beam along the second direction, wherein the light guide module comprises:
a first light splitting element, configured to allow the second light beam to pass through;
a second light splitting element, configured to allow the second light beam to pass through, so that the first light beam, the second light beam, and the third light beam are all transmitted along the second direction, the second light splitting element is at the downstream of the first light splitting element; and
a reflecting mirror, configured to guide the third light beam to the first light splitting element or the second light splitting element;
wherein the first light splitting element and the second light splitting element are stripe beam splitters, and a stripe extension direction of the first light splitting element and a stripe extension direction of the second light splitting element are substantially orthogonal to each other,
wherein the illumination light beam comprises at least one of the first light beam, the second light beam, and the third light beam, the light valve is disposed on a transmission path of the illumination light beam, the light valve is configured to convert the illumination light beam into an image light beam, the projection lens is disposed on a transmission path of the image light beam, and the projection lens is configured to project the image light beam out of the projection device.
